(19) United States
(12) Patent Application Publication
(10) Pub. No.: US 2008/0228905 A1
(43) Pub. Date: Sep. 18, 2008

(54) Travelers/Commuters Portable Staging Device

(76) Inventor: Thomas W. Lynch, Galveston, TX (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/685,680

(22) Filed: Mar. 13, 2007

(51) Int. Cl. G06F 15/173

(52) U.S. Cl. 709/223

(57) ABSTRACT

One embodiment of a staging device comprises a power source capable of supplying power to a plurality of different portable devices, at least two portable devices having different power requirements. The power source comprises a fuel cell, a gel cell, a battery and/or a nuclear battery. Another embodiment of a staging device comprises a storage device capable of storing at least one of a message and data intended to be received by at least one of a plurality of portable devices, at least two portable devices having a different communication format. A controller coupled to the storage device is capable of converting the message and/or the data stored in the storage device to a communication format that is appropriate for an intended portable device.

### TECHNICAL FIELD

The subject matter disclosed herein relates to a system for managing a plurality of portable devices. More particularly, the subject matter disclosed herein relates to a system for managing a plurality of portable devices, connectors, protocols, and power sources currently available in the electronics market.

### BRIEF DESCRIPTION OF THE DRAWINGS

The subject matter disclosed herein is illustrated by way of example and not by limitation in the accompanying figures in which like reference numerals indicate similar elements and in which:

FIG. 1 depicts a functional block diagram of one exemplary embodiment of a staging device according to the subject matter disclosed herein;

FIG. 2 depicts an exemplary process of sending a message and/or data between two portable devices according to the subject matter disclosed herein;

FIG. 3 depicts an exemplary conversion procedure according to the subject matter disclosed herein; and

FIG. 4 depicts an exemplary embodiment of a staging device comprising a fuel-cell storage container according to the subject matter disclosed herein.

### DETAILED DESCRIPTION

The word “exemplary” is used herein to mean “serving as an example, instance, or illustration.” Any embodiment described herein as “exemplary” is not to be construed as necessarily preferred or advantageous over other embodiments.

In today's world, professionals, executives and engineers among others are increasingly finding themselves in exotic environments filled with various portable devices, various power sources, various communications protocols and various physical connectors. Additionally, the rapid movement of technology assures that a plethora of devices, power sources, communications protocols and physical connectors exist simultaneously during the serviceable lifetime windows for devices. The communication connection problem grows in combinatorially with the power/power connector and communication protocol options, thereby quickly producing an unmanageable set of solutions. One exemplary embodiment of the subject matter disclosed herein relates to a portable central staging area for holding portable devices so that the portable devices may connect to a more immediately known quantity instead of to a plurality of other different devices and/or power sources, thereby changing the combinatorial problem of combining portable devices into a linear problem with the subject matter disclosed herein as a portable hub of a portable cluster. The subject matter disclosed herein enables those who experience shifts in the technology milieu, such as modern professionals and travelers among others, to use more devices in more places, while also providing vendors of new devices with a larger selection of compatible devices.

The subject matter disclosed herein relates to a system for managing a plurality of portable devices, connectors, protocols, and power sources currently available in the electronics market. Examples of such portable devices include, but are not limited to, Personal Digital Assistants (PDAs), cell phones, Personal Communication System (PCS) devices, Global Positioning Systems (GPSs), MP3 players, video players, digital cameras, video cameras, laptop computers, tablet PCs, handheld PCs, special-purpose devices, application-specific devices and satellite equipment.

The subject matter disclosed herein provides a staging device comprising a storage device capable of receiving and storing at least one of a message and data intended to be received by at least one portable device, and a power source capable of supplying power to a portable device intended to receive at least one of the message and data stored in the storage device. The power source comprises at least one of a fuel cell, a gel cell, a battery and a nuclear battery. One exemplary embodiment of the staging device provides that the battery is capable of being charged by one of the fuel cell and the gel cell. One exemplary embodiment of the staging device provides that the power source further comprises a power supply capable of supplying power to at least one portable device. Another exemplary embodiment of the staging device provides that the power source is further capable of receiving energy from an external alternating current power source. One exemplary embodiment of the staging device further comprises a controller coupled to the storage device capable of converting at least one of the message and the data stored in the storage device to a communication format that is appropriate for an intended portable device. One exemplary embodiment of the staging device provides that the storage device is selectively coupled to at least one portable device by at least one of a wired communication link and a wireless communication link. Another exemplary embodiment of the staging device provides that the power source device is selectively coupled to at least one portable device by at least one of a wired power transfer link and a wireless power transfer link. The staging device can be configured as, but is not limited to, one of a bag, a sack, a backpack, a briefcase, a tool case, an equipment case, a ditty bag, and an article of clothing.

One exemplary embodiment of the subject matter disclosed herein comprises a staging device that is portable and is typically carried from place-to-place by a user so that the user has access to the functionality of the staging device. One exemplary embodiment of the subject matter disclosed herein is configured as a bag, a backpack or a sack that has been enhanced with a number of features, such as one or more custom-sized holding areas, embedded electronics, a communications capability, expanded data storage, power supplies, power supply fuel, and system heating and cooling. Other exemplary configurations of the staging device according to the subject matter disclosed herein include, but are not limited to, a brief case, a tool case, an equipment case, a ditty bag, or an article of clothing, such as a jacket or a pair of pants.

One embodiment of a staging device according to the subject matter disclosed herein comprises connectors and/or ports for providing a communications link and/or a power supply link between a portable electronic device and the staging device. Additionally or alternatively, a staging device comprises wireless communications capability, such as, but not limited to, radio frequency (RF) communications capability and/or infrared communications capability, for providing a communications link and/or a power transfer link between the staging device and one or more portable electronic devices.

A user intending to send a message and/or data between multiple portable devices may send the message and/or the data to the staging device, even though only one portable device at a time available and/or powered on and the other intended devices are unavailable and/or powered off. The staging device stores the message and/or data until the desired destination portable device is available, at which time the staging device forwards the message and/or data.

In one exemplary embodiment, a staging device according to the subject matter disclosed herein provides a single point for connecting all portable devices into a power source. Accordingly, portable devices may be left in the staging device, tethered to the staging device, or left charging in the staging device, during active use of the portable device and/or during quiescent charging cycles.

In one exemplary embodiment, the staging device includes an electrical energy storage device, such as a battery fuel cell, a nuclear power battery and/or a gel-cell power source, that allows the staging device to provide power to several portable devices for a length of time that exceeds the battery life of the individual portable devices. For example, a handheld GPS unit may have significant power requirements, but be physically smaller than commonly available battery formats that would be capable of supplying power for any appreciable length of time. In another exemplary embodiment, the staging device itself is plugged into, for example, a wall receptacle and the GPS device may be left tethered to the staging device via a power cord or via inductive coupling. In yet another exemplary embodiment, the GPS device may contain rechargeable batteries that are recharged when the GPS is coupled to the staging device. It should be understood that other portable devices, not just GPS devices, could be tethered to a staging device.

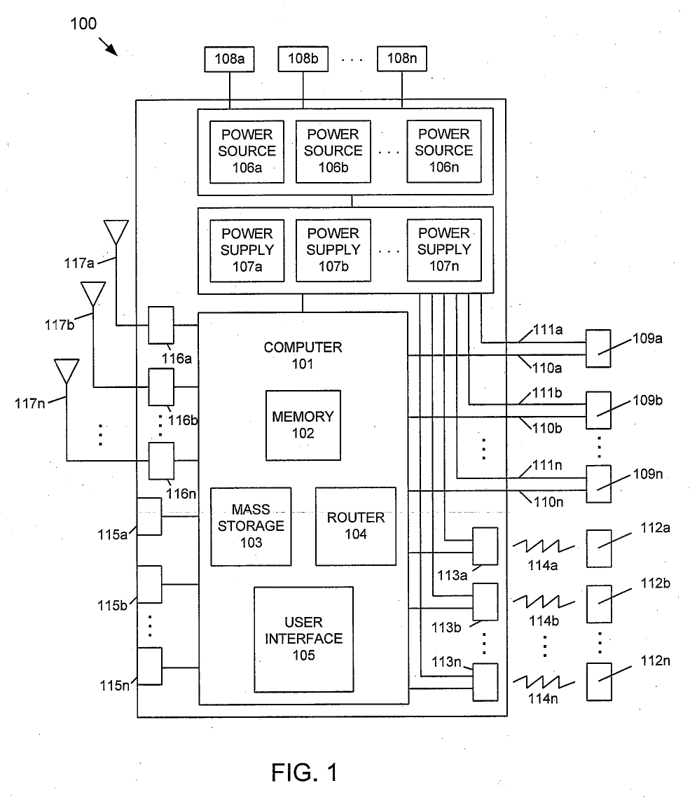

FIG. 1 depicts a functional block diagram of one exemplary embodiment of a staging device 100 according to the subject matter disclosed herein. Staging device 100 comprises a computer 101, a memory 102, a mass storage device 103, a router 104, a user interface device 105, at least one power source 106, at least one power supply 107 and a plurality of portable device stations or positions, depicted in FIG. 1 as connectors 108a-108n. Computer 101 is capable of controlling functionality of staging device 100. In one exemplary embodiment, computer 101 is embodied as a microprocessor. Alternatively, computer 101 could be embodied as, but not limited to, a personal computer (PC) mother board, a PC104 board or an instrumentation-standards board or a microcontroller-based system. Further still, computer 101 could be embodied as one of the portable devices that couple to connectors 108a-108n. Additionally, computer 101 could run many types of programs and/or provide many types of functions beyond the programs and functions explicitly described herein.

Computer 101 is coupled to memory 102 in a well-known manner. Memory 102 is capable of storing messages and/or data that is intended for communications between portable devices. Additionally, when computer 101 is configured to execute machine-executable instructions, memory 102 is further capable of storing the machine-executable instructions and other operating state conditions for computer 101. In one exemplary embodiment, memory 102 comprises random-access memory (RAM). In another exemplary embodiment, memory 102 comprises read-only memory (ROM). In yet another exemplary embodiment, memory 102 comprises a mass storage capability, in which case mass storage device 103 could still be used. In still another exemplary embodiment, memory 102 comprises a storage capability that is removable from staging device 100, such as, but not limited to, a ZIP drive, a CD-ROM, a flash drive, a memory module and/or a floppy disk. Computer 101 is coupled to mass storage device 103 in a well-known manner. Mass storage device 103 is capable of storing messages and/or data that is intended for communications between portable devices. In one exemplary embodiment, mass storage device 103 comprises a hard disk drive and/or an optical storage device. In another exemplary embodiment, mass storage device 103 comprises a mass storage capability that is removable from staging device 100, such as, but not limited to, a ZIP drive, a CD-ROM, a flash drive, a memory module and/or a floppy disk. Mass storage device 103 is depicted as being external to computer 101, but alternatively be internal to computer 101.

Computer 101 is coupled to router 104 in a well-known manner. Router 104 provides communications routing functionality in a well-known manner. In one exemplary embodiment, router 104 is a separate component from computer 101. In another exemplary embodiment, computer 104 provides router functionality.

User interface device 105 is coupled to processor/controller 101 in a well-known manner and provides capability for processor/controller 101 for receiving input commands and/or data from a user for controlling operation of staging device 100. In one exemplary embodiment user interface device 105 comprises a keypad or a keyboard. In another exemplary embodiment, user interface device 105 comprises a display capability (not shown in FIG. 1) for indicating operating states and conditions of staging device 100 and for allowing a user to select functional features. When user interface device 105 provides a display capability, user interface could also provide a touch-screen input capability. While FIG. 1 depicts user interface device 105 as coupled to processor/controller 101 in a well-known manner through a hardwired communication link (not shown), it should be understood that user interface device 105103 could alternatively be coupled to processor/controller 101 in a well-known manner through a wireless communication link (not shown), such as, but not limited to, an RF and/or an infrared communication link.

Power source 106 comprises at least one energy source 106a-106n, such as one or more batteries, gel-cell devices, fuel-cell devices, and/or nuclear-type batteries. Alternatively, power source 106 comprises a line cord that plugs into a wall receptacle. Power source 106 provides energy to power supply 107, which conditions the energy provided by power source 106 in a well-known manner to provide selected AC and/or DC voltages and currents for powering different portable devices and/or charging the batteries of the different portable devices. That is, power supply 107, which is depicted in FIG. 1 as a plurality of power supplies 107a-107n, is capable of receiving AC and/or DC power and providing AC/AC conversion and/or AC/DC conversion through a variety of connectors or power couplings 108a-108n. In one exemplary embodiment, power supply 107 is capable of receiving energy from an energy source, such as one or more batteries, gel-cells devices, fuel-cell devices and/or nuclear batteries, and from a wall receptacle. In another exemplary embodiment, power supply 107 is capable of receiving energy from a plurality of different AC line voltages and frequencies and DC voltages. In yet another exemplary embodiment, power source 106 comprises rechargeable batteries. In still another exemplary embodiment, fuel-cell batteries generate power for recharging the conventional-type batteries of the staging device.

Connectors 109a-109n are adapted to receive different portable devices (not shown in FIG. 1). Connectors 109a-109n are respectively coupled to computer 101 through hardwired connections 110a-110n. Connections 110a-110n are used for transferring messages and/or data stored in memory 102 to selected portable devices that are respectively coupled to connectors 109a-109n. As depicted in FIG. 1, connectors 109a-109n are also respectively coupled to power supply 107 through connections 111a-111n. The voltages and currents supplied by power supply 107 correspond to the requirements of each respective portable device that is connected to staging device 100. Connectors 112a-112n are respectively coupled in a well-known manner to a wireless transceivers 113a-113n of staging device 100 over a wireless links 114a-114n. Wireless links 114a-114n can be, for example, RF and/or infrared wireless links. In one exemplary embodiment, a wireless link 114 includes both communication and power transfer capability. In another exemplary embodiment, a wireless link 114 provides only one of a communication or a power transfer capability. In still another exemplary embodiment, wireless transceiver may have a sensitive receiver portion and/or a relatively powerful transmitter portion for communications and/or a power-transfer capability for staging a portable device from a distance. While connectors 112 are depicted as connectors, it should be understood that alternatively a connector 112 could be a portable device having a wireless connection capability.

While FIG. 1 depicts three connectors 109a-109n that are hardwire coupled to staging device 100 and three connectors 112a-112n that is wirelessly coupled to staging device 100, it should be understood that any number of hardwire coupled and/or wirelessly coupled connectors could be used. Additionally, while connectors 108a-108n are depicted as providing communications and power-transfer capability, it should be understood that any one of connectors 108 and/or 111 could provide only one of a communications capability or a power-transfer capability. While FIG. 1 depicts connectors 108a-108n as being coupled to staging device 100 through a length of wire, it should be understood that one or more connectors 108 could be physically attached to staging device 100 in a well-known manner to form a docking-type station for a portable device.

One exemplary embodiment of staging device 100 comprises at least one I/O port 115 that can be coupled to, for example, an external communications network, such as a Local Area Network (LAN), a Wide Area Network (WAN), the Internet and/or a Public Switched Telephone Network (PSTN). In particular, FIG. 1 depicts a plurality of I/O ports 115a-115n. Another exemplary embodiment of staging device 100 comprises at least one transceiver 116 that is coupled to an antenna 117 for communication in a well-known manner with, for example, a wireless communications network, a cellular telephone network, a PCS network and/or a Wireless LAN (WLAN). In particularly, FIG. 1 depicts a plurality of transceivers 116a-116n and corresponding antennas 117a-117n.

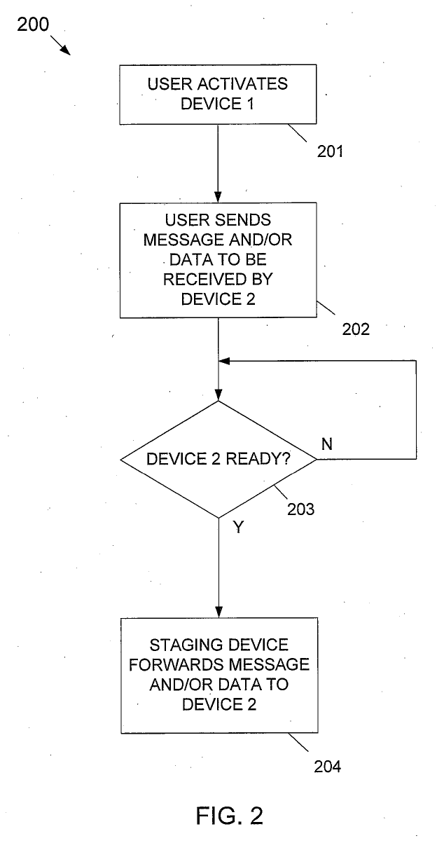

FIG. 2 depicts an exemplary process 200 of sending a message and/or data between two portable devices. At step 201, a user activates a first portable device (device 1), such as by powering device 1 on. At step 202, the user sends a message and/or data intended for a second portable device (device 2) to the staging device. At step 203, the staging device determines whether the second device is ready to receive the message and/or data. When the staging device determines that the second device is ready to receive the message and/or data, flow continues to step 204 where the staging device forwards the message and/or data to the second device. While FIG. 2 depicts the situation in which a user forwards a message and/or data through the staging device to a single intended device, it should be understood that a plurality of messages and/or data can be forwarded through the staging device to a plurality of intended portable devices. It should be understood that the subject matter disclosed herein provides variations of message and/or data transfer, such as providing an appropriate and/or a selectable delay in message and/or data transfer for each portable device.

One exemplary embodiment of staging device 100 provides a notification to a user of the existence of a message and/or data for a particular device on another device. In one alternative embodiment, in addition to coordinating messages and/or data between devices directly serviced by the staging device, the staging device coordinates messages and/or data between servers and devices. For example, if all devices are deactivated and stowed in proximity to the staging device, the staging device may accept messages and/or data for one or more of the devices, and then forward the messages and/or data at an appropriate time, such as when the device is activated. One exemplary embodiment of a staging device communicates in a well-known manner with another staging device for purposes of caching messages and/or data for served devices. In another exemplary embodiment, synchronization is supported in a well-known manner so that the same or similar data may be maintained on a number of devices, including the devices supported by the staging device.

One exemplary embodiment of staging device 100 supports conversion between protocols in order to facilitate communication between portable devices. For example, the staging device may provide, but is not limited to, Bluetooth-based communication functionality, infrared-based communication functionality, IEEE-802.11-based communication functionality, USB-based communication functionality, Ethernet-based communication functionality, WiFi communication functionality, Firewire communication functionality and/or IEEE-1588-based communication functionality. In another exemplary embodiment, staging device 100 converts cellular telephone and broadcast standards, such as, but not limited to, GSM, TDMA and CDMA, to other communication protocols in a well-known manner, such as the communication standards that are used in other countries. In another exemplary embodiment, protocol conversions are provided for a number of message and/or data types including, but not limited to, email, audio, raw data, images, video, and text. In still another exemplary embodiment, protocol conversion is provided between all protocol types on all protocol layers, such as described by the IEEE-802-based standards, USB-based standards, Ethernet-based standards, WiFi communication functionality, Firewire communication functionality and/or IEEE-1588-based communication functionality. In yet another exemplary embodiment, staging device 100 is communicatively coupled to an entity that is external to staging device 100, such as, but not limited to a wireless hub, a personal computer or an appliance, and converts messages and/or data between different protocols for the external entity. For this exemplary embodiment, the external entity could communicate using a communication protocol that is different from the communication protocols of portable devices associated with staging device 100.

Yet another exemplary embodiment of staging device 100 provides firewall functionality for portable devices associated with staging device 100. Additionally or alternatively, staging device 100 can monitor and provide analysis information relating to communication events occurring between different portable devices and/or between selected portable devices and other external entities, and/or powering events for different portable devices.

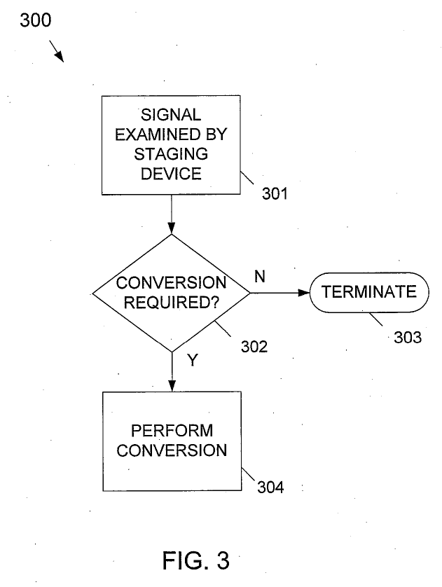

FIG. 3 depicts an exemplary conversion procedure 300 according to the subject matter disclosed herein. At step 301, a signal received in a first protocol is examined by the staging device. At step 302, it is determined whether the first protocol must be converted to a second protocol. If not, flow continues to step 303 where the process is terminated. If, at step 302, it is determined that the first protocol must be converted to the second protocol, flow continues to step 304 where the conversion is performed in a well-known manner. In one exemplary embodiment, protocol conversion occurs in real time or near real time. In another exemplary embodiment, entire messages and/or data are collected by the staging device, and then forwarded to the appropriate portable device at a later time using a protocol that is compatible for the destination device.

In addition to message, data coordination and/or protocol conversion, another exemplary embodiment of staging device 100 provides compatibility for various physical connectors, such as connectors 109, 112 and/or connectors 115 depicted in FIG. 1. For example, physical connectors can be specified as part of a protocol, such as an RJ-11 connector with respect to an Ethernet protocol. Additionally, connectors 109, 112 and/or 115 can be country dependent and/or vendor dependent.

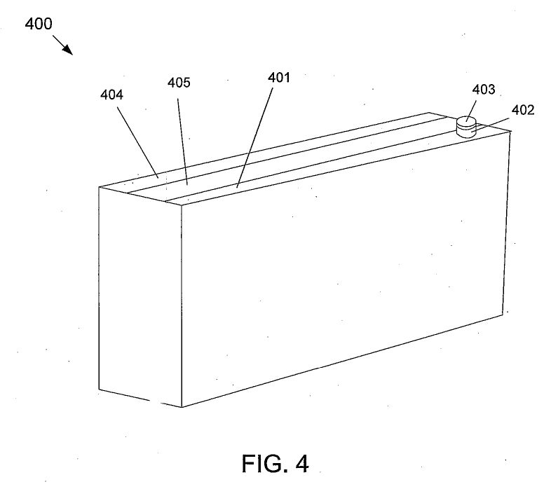

In an exemplary embodiment that uses fuel-cell technology, a staging device according to the subject matter disclosed herein comprises a storage container for safely holding liquid fuel. FIG. 4 depicts an exemplary embodiment of a staging device 400 comprising a fuel-cell storage container 401. Fuel-cell storage container 401 includes a fill opening 402 and cap 403. Staging device 400 also comprises exemplary slots 404 and 405 for receiving portable devices (not shown in FIG. 4). In one exemplary embodiment of staging device 400, fuel-cell storage container 401 comprises soft, pliable walls, and may comprise internal baffles in order to minimize fuel sloshing. The most common fuel for fuel cells is expected to be hydrous alcohol of such proportion as to be non-flammable. When, however, a flammable fuel is used, the staging device comprises a flame retardant that would form, for example, a bladder that completely surrounds the fuel bladder so that that punctures to the fuel bladder are highly likely to also puncture the flame retardant bladder.

In yet another exemplary embodiment, a staging device according to the subject matter disclosed herein comprises a nuclear battery. The radioactive source of the nuclear battery inundates a cathode and anode pair in a well-known manner to produce electrical current. A bladder or compartment surrounding around the radioactive battery protects a user from radiation exposure.

It will be obvious to those having skill in the art that many changes may be made to the details of the above-described embodiments without departing from the underlying principles of the invention. The scope of the present invention should, therefore, be determined only by the following claims.

1. A staging device, comprising: a power source capable of supplying power to a plurality of different portable devices, at least two portable devices having different power requirements.

2. The staging device according to claim 1, wherein the power source comprises one of a fuel cell and a gel cell.

3. The staging device according to claim 2, wherein the power source further comprises a battery.

4. The staging device according to claim 3, wherein the battery is capable of being charged by one of the fuel cell and the gel cell.

5. The staging device according to claim 2, wherein the power source further comprises a power supply capable of supplying power to at least one portable device.

6. The staging device according to claim 2, wherein the power source is further capable of receiving energy from an external alternating current power source.

7. The staging device according to claim 1, wherein the power source comprises a fuel cell, and
wherein the staging device further comprises a storage container capable of storing fuel for the fuel cell.

8. The staging device according to claim 1, wherein the power source comprises a nuclear battery.

9. The staging device according to claim 1, further comprising a storage device capable of storing at least one of a message and data intended to be received by at least one portable device.

10. The staging device according to claim 9, wherein the storage device is further capable of receiving at least one of a message and data intended to be received by at least one portable device.

11. The staging device according to claim 9, further comprising a controller coupled to the storage device capable of converting at least one of the message and the data stored in the storage device to a communication format that is appropriate for an intended portable device.

12. The staging device according to claim 9, wherein the storage device is selectively coupled to at least one portable device by at least one of a wired communication link and a wireless communication link.

13. The staging device according to claim 9, wherein the power source device is selectively coupled to at least one portable device by at least one of a wired power transfer link and a wireless power transfer link.

14. The staging device according to claim 1, wherein the staging device comprises one of a bag and a sack.

15. The staging device according to claim 1, wherein the staging device comprises a backpack.

16. The staging device according to claim 1, wherein the staging device comprises one of a briefcase, a tool case, an equipment case and a ditty bag.

17. The staging device according to claim 1, wherein the staging device comprises an article of clothing.

18. A staging device, comprising: a storage device capable of storing at least one of a message and data intended to be received by at least one of a plurality of portable devices, at least two portable devices having a different communication format.

19. The staging device according to claim 18, further comprising a power source capable of supplying power to a portable device intended to receive at least one of the message and data stored in the storage device.

20. The staging device according to claim 19, wherein the power source comprises one of a fuel cell and a gel cell.

21. The staging device according to claim 20, wherein the power source further comprises a battery.

22. The staging device according to claim 21, wherein the battery is capable of being charged by one of the fuel cell and the gel cell.

23. The staging device according to claim 20, wherein the power source further comprises a power supply capable of supplying power to at least one portable device.

24. The staging device according to claim 20, wherein the power source is further capable of receiving energy from an external alternating current power source.

25. The staging device according to claim 19, wherein the power source comprises a fuel cell, and
wherein the staging device further comprises a storage container capable of storing fuel for the fuel cell.

26. The staging device according to claim 19, wherein the power source comprises a nuclear battery.

27. The staging device according to claim 19, wherein the storage device is further capable of receiving at least one of a message and data intended to be received by at least one portable device.

28. The staging device according to claim 18, further comprising a controller coupled to the storage device capable of converting at least one of the message and the data stored in the storage device to a communication format that is appropriate for an intended portable device.

29. The staging device according to claim 18, wherein the storage device is selectively coupled to at least one portable device by at least one of a wired communication link and a wireless communication link.

30. The staging device according to claim 18, wherein the power source device is selectively coupled to at least one portable device by at least one of a wired power transfer link and a wireless power transfer link.

31. The staging device according to claim 18, wherein the staging device comprises one of a bag and a sack.

32. The staging device according to claim 18, wherein the staging device comprises a backpack.

33. The staging device according to claim 18, wherein the staging device comprises one of a briefcase, a tool case, an equipment case and a ditty bag.

34. The staging device according to claim 18, wherein the staging device comprises an article of clothing.

35. A staging device, comprising: a power-source means for supplying power to a plurality of portable devices, at least two portable devices having different power requirements.

36. The staging device according to claim 35, wherein the power-source means comprises one of a fuel cell and a gel cell.

37. The staging device according to claim 36, wherein the power-source means further comprises a battery.

38. The staging device according to claim 37, wherein the battery is capable of being charged by one of the fuel cell and the gel cell.

39. The staging device according to claim 36, wherein the power-source means further comprises power-supply means for supplying power to at least one portable device.

40. The staging device according to claim 36, wherein the power-source means is capable of receiving energy from an external alternating current power source.

41. The staging device according to claim 35, wherein the power-source means comprises a fuel cell, and
wherein the staging device further comprises storage-container means for storing fuel for the fuel cell.

42. The staging device according to claim 35, wherein the power-source means comprises a nuclear battery.

43. The staging device according to claim 35, further comprising storage means for storing at least one of a message and data intended to be received by at least one portable device.

44. The staging device according to claim 43, wherein the storage means is further for receiving at least one of a message and data intended to be received by at least one portable device.

45. The staging device according to claim 43, further comprising means coupled to the storage device for converting at least one of the message and the data stored in the storage device to a communication format that is appropriate for an intended portable device.

46. The staging device according to claim 43, wherein the storage means is selectively coupled to at least one portable device by at least one of a wired communication link and a wireless communication link.

47. The staging device according to claim 43, wherein the power-source means is selectively coupled to at least one portable device by at least one of a wired power transfer link and a wireless power transfer link.

48. The staging device according to claim 35, wherein the staging device comprises one of a bag and a sack.

49. The staging device according to claim 35, wherein the staging device comprises a backpack.

50. The staging device according to claim 35, wherein the staging device comprises one of a briefcase, a tool case, an equipment case and a ditty bag.

51. The staging device according to claim 35, wherein the staging device comprises an article of clothing.

52. A staging device, comprising: storage means for storing at least one of a message and data intended to be received by at least one of a plurality of portable devices, at least two portable devices having a different communication format.

53. The staging device according to claim 52, further comprising a power-source means for supplying power to a plurality of portable devices, at least two portable devices having different power requirements.

54. The staging device according to claim 52, wherein the power-source means comprises one of a fuel cell and a gel cell.

55. The staging device according to claim 52, wherein the power-source means further comprises a battery.

56. The staging device according to claim 55, wherein the battery is capable of being charged by one of the fuel cell and the gel cell.

57. The staging device according to claim 54, wherein the power-source means further comprises power-supply means for supplying power to at least one portable device.

58. The staging device according to claim 54, wherein the power-source means is capable of receiving energy from an external alternating current power source.

59. The staging device according to claim 53, wherein the power-source means comprises a fuel cell, and
wherein the staging device further comprises storage-container means for storing fuel for the fuel cell.

60. The staging device according to claim 53, wherein the power-source means comprises a nuclear battery.

61. The staging device according to claim 52, wherein the storage means is further for receiving at least one of a message and data intended to be received by at least one portable device.

62. The staging device according to claim 52, further comprising controller means coupled to the storage device for converting at least one of the message and the data stored in the storage device to a communication format that is appropriate for an intended portable device.

63. The staging device according to claim 52, wherein the storage means is selectively coupled to at least one portable device by at least one of a wired communication link and a wireless communication link.

64. The staging device according to claim 52, wherein the power-source means is selectively coupled to at least one portable device by at least one of a wired power transfer link and a wireless power transfer link.

65. The staging device according to claim 52, wherein the staging device comprises one of a bag and a sack.

66. The staging device according to claim 52, wherein the staging device comprises a backpack.

67. The staging device according to claim 52, wherein the staging device comprises one of a briefcase, a tool case, an equipment case and a ditty bag.

68. The staging device according to claim 52, wherein the staging device comprises an article of clothing.

69. A staging device, comprising:
a storage device capable of storing at least one of a message and data intended to be received by at least one portable device;
a controller coupled to the storage device, the controller being capable of converting at least one of the message and the data stored in the storage device to a communication format that is appropriate for an intended portable device; and
a power source capable of supplying power to a portable device intended to receive at least one of the message and data stored in the storage device.

70. The staging device according to claim 69, wherein the power source comprises one of a fuel cell and a gel cell.

71. The staging device according to claim 69, wherein the power source further comprises a battery.

72. The staging device according to claim 71, wherein the battery is charged by one of the fuel cell and the gel cell.

73. The staging device according to claim 70, wherein the power source further comprises a power supply capable of supplying power to at least one portable device.

74. The staging device according to claim 70, wherein the power source is further capable of receiving energy from an external alternating current power source.

75. The staging device according to claim 69, wherein the power source comprises a fuel cell, and
wherein the staging device further comprises a storage container capable of storing fuel for the fuel cell.

76. The staging device according to claim 69, wherein the power source comprises a nuclear battery.

77. The staging device according to claim 69, wherein the storage device is further capable of receiving at least one of a message and data intended to be received by at least one portable device.

78. The staging device according to claim 69, wherein the storage device is selectively coupled to at least one portable device by at least one of a wired communication link and a wireless communication link.

79. The staging device according to claim 69, wherein the power source device is selectively coupled to at least one portable device by at least one of a wired power transfer link and a wireless power transfer link.

80. The staging device according to claim 69, wherein the staging device comprises one of a bag and a sack.

81. The staging device according to claim 69, wherein the staging device comprises a backpack.

82. The staging device according to claim 69, wherein the staging device comprises one of a briefcase, a tool case, an equipment case and a ditty bag.

83. The staging device according to claim 69, wherein the staging device comprises an article of clothing.
